(19) United States
(12) Patent Application Publication
(10) Pub. No.: US 2012/0208909 A1
(43) Pub. Date: Aug. 16, 2012

(54) POLYMER MIXTURES OF POLYSTYRENE HAVING STYRENE BUTADIENE BLOCK COPOLYMERS

(75) Inventors: Norbert Niessner, Friedelsheim (DE); Rogelio Chavez, Col. Ciudad De Los Deportes (MX)

(73) Assignee: BASF SE, Ludwigshafen (DE)

(21) Appl. No.: 13/500,383

(22) PCT Filed: Oct. 5, 2010
(86) PCT No.: PCT/EP2010/064778

§ 371 Date: Apr. 5, 2012

(30) Foreign Application Priority Data
Oct. 9, 2009 (EP) 09172692.7

(51) Int. Cl. C08L 53/02; C08J 9/00

(52) U.S. Cl. 521/81; 521/139

(57) ABSTRACT

The invention relates to a mixture comprising: a) 1 to 40% by weight of a styrene-butadiene-styrene block copolymer having 1.) 60 to 95% by weight of styrene monomer and 2.) 5 to 50% by weight of diene monomer; b) 60 to 99% by weight of styrene polymer; c) 0 to 50% by weight of a filler; and d) 0.1 to 20% by weight of a foaming additive, the sum of the components a) to d) being 100% by weight.

The invention relates to a mixture which comprises
a) from 1 to 40% by weight of a styrene-butadiene-styrene block copolymer having
   1.) from 60 to 95% by weight of styrene monomer and
   2.) from 5 to 50% by weight of diene monomer,
b) from 60 to 99% by weight of styrene polymer,
c) from 0 to 50% by weight of a filler, and
d) from 0.1 to 20% by weight of a foam-forming additive,
   where the entirety of components a) to d) gives 100% by weight.

DE-A-44 16 862 discloses expandable styrene polymers for elastic polystyrene foams which comprise polystyrene and styrene-butadiene-styrene block copolymers. The specification relates exclusively to expandable styrene polymers, i.e. polystyrene beads obtainable by way of suspension polymerization having, for example, pentane as blowing agent, these being foamed by exposure to heat/steam, but without any formulation of an intimate blend with the other components.

EP-A-313 653 (WO-A-88/08864) discloses foams made of polyolefin/polystyrene resin mixtures which are produced via mixing of a polyolefin resin and of a polystyrene resin in the presence of a hydrogenated styrene-butadiene block copolymer, and also extruded foams made of the resultant resin composition in the presence of a blowing agent.

U.S. Pat. No. 6,268,046 discloses foamable mixtures comprising two different styrene polymers with CO₂ as blowing agent. Addition of elastomeric styrene/butadiene copolymer is described for increasing the overall elasticity of the moldings.

EP-A-1 730 221 (WO-A-2005/095501) discloses foams made of polystyrene, comprising low-molecular-weight random styrene-butadiene copolymers. This reduces the compressive strength and flexural strength of the foam from 60 to 40 days.

EP-A-1 930 365 discloses foams based on expandable polystyrene, on a blowing agent, and on styrene-butadiene block copolymers.

JP-A-08/041 233 discloses foamed foils for use in microwave ovens. The desired effect (high heat resistance with gradual improvement in toughness) is obtained here via small amounts of styrene-butadiene block copolymers as blend component in polystyrene.

DE-A-10 2004 055 539 discloses mixtures comprising mineral fillers, and also thermoplastic elastomers based on styrene.

A disadvantage of the abovementioned polymers is that no method is described for improving both toughness and stiffness of foams.

The present invention was based on the object of eliminating the abovementioned disadvantages.

Novel and improved mixtures have accordingly been found, and comprise
a) from 1 to 40% by weight of a styrene-butadiene-styrene block copolymer having
   1.) from 60 to 95% by weight of styrene monomer and
   2.) from 5 to 50% by weight of diene monomer,
b) from 60 to 99% by weight of styrene polymer,
c) from 0 to 50% by weight of a filler, and
d) from 0.1 to 20% by weight of an additive,
   where the entirety of components a) to d) gives 100% by weight.

The mixtures of the invention comprise, and preferably consist of, from 1 to 40% by weight, preferably from 2 to 30% by weight, particularly preferably from 5 to 10% by weight, of styrene-butadiene-styrene block copolymer (component A), from 60 to 99% by weight, preferably from 70 to 98% by weight, particularly preferably from 90 to 95% by weight, of polystyrene (component B), from 0 to 50% by weight, preferably from 0.1 to 20% by weight, particularly preferably from 1 to 10% by weight, of a filler (component C), and from 0.1 to 20% by weight, preferably from 0.2 to 15% by weight, particularly preferably from 0.5 to 10% by weight, of an additive (component D).

### Component A:

The form in which styrene and butadiene are present in the styrene-butadiene-styrene block copolymer of the invention is predominantly, preferably at least 95%, particularly preferably 98%, in particular 99%, very particularly preferably 100%, polymerized form. The content of at least one copolymerized styrene monomer is from 60 to 95% by weight, preferably from 65 to 90% by weight, particularly preferably from 70 to 80% by weight (component a1.). The content of at least one copolymerized diene monomer is from 5 to 40% by weight, preferably from 10 to 35% by weight, particularly preferably from 20 to 30% by weight.

Other styrene monomers that can be used alongside, or in a mixture with, styrene are vinylaromatic monomers which have substitution by C₁-C₂₀ hydrocarbon moieties on the aromatic ring and/or at the C═C double bond, preference being given to styrene, α-methylstyrene, and p-methylstyrene, and particular preference being given to styrene.

Examples of suitable diene components are butadiene, pentadiene, dimethylbutadiene, and isoprene, preferably butadiene and isoprene, particularly preferably butadiene. It is moreover also possible to add comonomers, e.g. acrylates, to said monomers. Other suitable comonomers are the monomers mentioned in DE-A 196 33 626 under M1-M10 in lines 5-50 on page 3. The block copolymers—known per se—are generally produced via anionic polymerization in a manner known to the person skilled in the art. Initiators used here usually comprise mono-, bi-, or polyfunctional alkyl, aryl, or aralkyl compounds of alkali metals. Examples that may be mentioned are n-butyllithium and sec-butyllithium. The preferred polymerization in solution can take place in an aliphatic, aromatic, or cycloaliphatic hydrocarbon, e.g. benzene, toluene, hexane, cyclohexane, heptane, or octane, optionally with addition of other substances, e.g. ethers. Materials known as retarders can be added if required to control reaction rate, examples being organyl compounds of magnesium or of aluminum. Once the polymerization has ended, a chain terminator can be used to terminate the living chains. Substances suitable for this purpose have active protons, examples being water, alcohols, and also inorganic acids, e.g. carbonic acid. In another preferred embodiment, the living chain ends, for example of a styrene-butadiene block, are bonded to one another via suitable coupling agents, thus often producing a mixture of linear styrene-butadiene block copolymers and of star-shaped styrene-butadiene block copolymers (having n arms).

The styrene-butadiene block copolymers A can, for example, be linear two-block S-B copolymers or linear three-block S-B-S or B-S-B copolymers (S=styrene block, B=butadiene block), these being the materials obtained via anionic polymerization in processes known per se. The block structure arises in essence through initial anionic polymerization of styrene alone, giving a styrene block. Once the styrene monomers have been consumed, the monomer is changed by adding monomeric butadiene, and the material is polymerized anionically to give a butadiene block (this being known as sequential polymerization). The resultant two-block S-B polymer can be polymerized to give a three-block S-B-S polymer via a further change of monomer to styrene, if desired. A corresponding principle applies for three-block B-S-B copolymers.

The two styrene blocks in the three-block copolymers can be of identical size (identical molecular weight, i.e. symmetrical S1-B-S1 structure) or of different size (different molecular weight, i.e. asymmetrical S1-B-S2 structure). The same principle applies analogously to the two butadiene blocks of the B-S-B block copolymers. Other block sequences: S-S-B or S₁-S₂-B, or S-B-B or S-B₁-B₂ are also possible, of course. The indices above represent the block sizes (block lengths or molecular weights). The block sizes depend by way of example on the amounts of monomer used and on the polymerization conditions.

There can also be BIS blocks instead of the elastomeric (soft) butadiene blocks B or in addition to the blocks B. The BIS blocks are likewise soft and comprise butadiene and styrene, for example randomly distributed or in the form of tapered structure (tapered=gradient from styrene-rich to styrene-poor or vice versa). If the block copolymer comprises a plurality of BIS blocks, the absolute amounts of, and the relative proportions of, styrene and butadiene in the individual BIS blocks can be identical or different (giving different blocks (B/S)₁, (B/S)₂, etc.). The generic term “mixed” blocks is also used for the BIS blocks—irrespective of whether they have a random or tapered structure or some other type of structure.

Other suitable styrene-butadiene block copolymers are four- and polyblock copolymers.

The block copolymers mentioned can have a linear structure (described above). However, branched and star-shaped structures are preferred. Branched block copolymers are obtained in a known manner, e.g. via graft reactions of polymeric “side branches” onto a main polymer chain.

Star-shaped block copolymers are obtainable by way of example via reaction of the living anionic chain ends with an at least bifunctional coupling agent. Coupling agents of this type are described for example in U.S. Pat. No. 3,985,830, U.S. Pat. No. 3,280,084, U.S. Pat. No. 3,637,554, and U.S. Pat. No. 4,091,053. Preference is given to epoxidized glycerides (e.g. epoxidized linseed oil or soy oil), silicon halides, such as SiCl₄, or else divinylbenzene, or else polyfunctional aldehydes, ketones, esters, anhydrides, or epoxides. Preference is equally given to carbonates, such as diethyl carbonate or ethylene carbonate (1,3-dioxolan-2-one). Specifically for the dimerization reaction, the following are also suitable: dichlorodialkylsilanes, dialdehydes, such as terephthaldehyde, and esters, such as ethyl formate or ethyl acetate.

By coupling identical or different polymer chains it is possible to produce symmetrical or asymmetrical star structures, i.e. the individual arms of the star can be identical or different, and in particular can comprise various S, B, B/S blocks or different block sequences. Further details concerning star-shaped block copolymers can be found by way of example in WO-A 00/58380.

Examples of styrene-butadiene-styrene block copolymers having from 60 to 95% by weight styrene content are K-Resin 01, K-Resin 03, K-Resin 05, K-Resin 10, Styrolux® 684D, Styrolux® 693 D, and Styrolux® 3G55.

### Component B:

Suitable styrene polymers are any of the usual polymers based on styrene monomers. Styrene monomers that can be used comprise any of the vinylaromatic monomers, for example styrene, α-methylstyrene, p-methylstyrene, ethylstyrene, tert-butylstyrene, vinylstyrene, vinyltoluene, 1,2-diphenylethylene, 1,1-diphenylethylene, or a mixture of these. The styrene polymers can be rubber-free or rubber-containing. Among the former is polystyrene (GPPS), and the latter are usually termed impact-resistant, an example being impact-resistant polystyrene (HIPS).

The rubbers comprised in the impact-resistant styrene polymers are in particular those based on diene monomers. Suitable diene monomers are any of the polymerizable dienes, in particular 1,3-butadiene, 1,3-pentadiene, 1,3-hexadiene, 2,3-dimethyl-butadiene, isoprene, piperylene, or a mixture thereof. Preference is given to 1,3-butadiene (abbreviated to: butadiene).

In one preferred embodiment, the process comprises use of polystyrene (GPPS), impact-resistant polystyrene (HIPS), or a mixture thereof, as styrene polymer. It is particularly preferable to use GPPS.

Examples thereof are: Polystyrol® 158 K and Polystyrol® 145 D from BASF SE, and also high-impact polystyrene (HIPS), by way of example Polystyrol® 486 M, Polystyrol® 476 L.

The styrene polymers can be produced in a manner known per se, for example via bulk, solution, emulsion, suspension, or precipitation polymerization of the monomers, or by combining these types of polymerization. The free-radical, anionic, or cationic initiators known to the person skilled in the art are usually used concomitantly for this purpose, as also are other auxiliaries.

The rubber content of the rubber-containing (impact-resistant) styrene polymers is generally from 0.1 to 12% by weight.

The weight-average molar masses of the rubber-containing styrene polymers are preferably from 80 000 to 500 000 g/mol, in particular from 100 000 to 400 000 g/mol, and the preferred weight-average molar masses of the rubber-free styrene polymers are preferably from 100 000 to 500 000 g/mol, in particular from 120 000 to 400 000 g/mol.

The styrene polymers used as starting material can comprise the known additional substances and processing aids (abbreviated to: additives), in the amounts usual for said materials, examples being lubricants or mold-release agents, colorants, e.g. pigments or dyes, flame retardants, antioxidants, stabilizers to counter the effect of light, fibrous and pulverulent fillers, or fibrous and pulverulent reinforcing agents, or antistatic agents, and also other additional substances, or a mixture of these.

In particular, the styrene monomers used can also comprise mineral oil in amounts of from 0 to less than 8% by weight. Other styrene polymers that can be used as starting material are those which already have low mineral oil content, i.e. up to less than 8% by weight. Products of this type are available commercially, an example being Polystyrol® 143E from BASF. Styrene polymers of this type comprising up to less than 8% by weight of mineral oil can be used with advantage in particular when the intention is to produce, as product, mineral-oil-containing styrene polymers with particularly high mineral oil content, for example from 20 to 50% by weight.

Suitable mineral oils are any of the liquid distillation products usually obtained from mineral feedstocks (petroleum, coal, wood, peat). They are generally composed of mixtures of saturated hydrocarbons, and are generally not saponifiable. Examples of suitable mineral oils are gasoline, diesel oils, heating oils, lubricating oils, kerosene, or insulating oils. Liquid paraffins are also suitable, i.e. mixtures of purified, saturated aliphatic hydrocarbons.

The density of the suitable mineral oils is preferably from 0.75 to 1.0 g/ml in accordance with DIN 51757 at 15° C. and their viscosity (kinematic) is preferably from 50 to 90 mm²/s in accordance with DIN 51562 at 40° C.

Mineral oils preferably used are white oils, in particular those which have approval under food legislation as additives for styrene polymers (polystyrenes, etc.) with food contact. An example of a white oil used with particular preference is Winog® 70 from Wintershall AG, a mineral oil with the following properties:
density: about 0.867 g/ml at 15° C. in accordance with DIN 51757
kinematic viscosity: about 70 mm²/s at 40° C. in accordance with DIN 51562
freezing point: about (−9)° C. in accordance with DIN/ISO 3016
flashpoint: about 266° C. in accordance with ISO 2592
insoluble in water.

The mineral oil content of the mineral-oil-containing styrene polymer in accordance with the invention is at least 8% by weight. It is preferably at most 50% by weight. It is particularly preferable that the mineral oil content is from 8 to 50% by weight, in particular being from 10 to 50% by weight. It is very particularly preferably from 15 to 40% by weight.

### Component C:

Any of the commercially available mineral fillers, such as talc, calcium carbonate, titanium dioxide, magnesium sulfate, magnesium oxide, calcium oxide, and aluminum oxide, preferably talc, calcium carbonate, and titanium dioxide.

### Component D:

Any of the commercially available blowing agents, such as carbon dioxide with or without alcohol, nitrogen, butane, pentane, or chemical blowing agents, such as sodium carbonate, potassium carbonate, or reaction products of citric acid.

The process for producing the mixtures of the invention can be carried out as follows:

In an extruder, preference being given here to a tandem extruder, component B is melted, and component A is introduced into the extruder already in the form of mixture with B or—alternatively—by way of a separate metering system. The two components are now heated beyond the glass transition temperature of B, so that they melt within the extruder. Component C is optionally added to the materials in the form of a mixture with A and/or B or—alternatively—through a separate metering system.

Separate metering systems can by way of example be: gear pumps (for components in the form of liquids/pastes), compounding extruders, stuffing screws.

Component D is typically added during or after the melting procedure. In the case of a chemical blowing agent—for example a mixture of citric acid and sodium bicarbonate—component D can also be added together in the form of a mixture with A and/or B. If component D is a physical blowing agent, it is preferably added to the plastic or molten melt, composed of components A, B, and optionally C.

Physical blowing agents are those which are gaseous at standard pressure (1 bar) below the respective extrusion temperatures.

The resultant mixture of components A to D is then extruded through a die, typically to produce a semifinished product (foil, film, hose, tube, etc.) which by virtue of the spontaneous expansion of the pressurized blowing agent has a foam structure.

In one preferred method, the melt is transferred prior to discharge through a die in another extruder (“tandem extruder”), which is generally intended to cool the low-viscosity mixture A-D and thus to convert it to a melt of higher viscosity. It is preferable here that a melt is cooled to from 110 to 150° C.

Typical extrusion temperatures (average temperatures of the melt in the extruder) are from 100 to 300° C., preferably from 110 to 275° C., and particularly preferably from 120 to 250° C.

The mixtures of the invention can be used in or as
foamed foils for food-and-drink packaging of any type (for example meat trays, vegetable trays),
XPS for the construction industry,
profiles for insulation or decoration (plastic-replacement),
foamed plates and cups,
foamed strips.

### EXAMPLES

A star-shaped S/B block copolymer was produced as in example 17 of WO-A-2000/058380 (in the subsequent table A: example 6), as component A.

TABLE A

| | | | Example No.: | | | | | | | |
|---|---|---|---|---|---|---|---|---|---|---|
| | Block | Unit | I | II | III | IV | V | VI | VII | VIII |
| Cyclohexane | | Liter | 643 | 643 | 643 | 643 | 643 | 643 | 643 | 643 |
| Styrene I | Sₐ | kg | 76.2 | 76.2 | 76.2 | 57.2 | 45.8 | 76.2 | 54.2 | 54.2 |
| sec-Butyllithium | | Liter | 0.788 | 0.788 | 0.788 | 0.788 | 0.788 | 1.05 | 0.9 | 0.9 |
| I 1.35 m | | | | | | | | | | |
| PTHL | | Liter | 1.057 | 1.057 | 1.057 | 1.057 | 1.057 | 1.096 | 0.698 | 0.442 |
| (3% by wt.) | | | | | | | | | | |
| sec-Butyllithium | | Liter | 2.757 | 2.757 | 2.757 | 2.757 | 2.757 | 2.625 | 1.44 | 1.44 |
| II 1.35 m | | | | | | | | | | |
| Styrene II | S_{b} | kg | 46.2 | 32.4 | 32.4 | 51.4 | 62.9 | 32.4 | 40.4 | 40.4 |
| Butadiene I | (B/S)₁ | kg | 52 | 10 | 10 | 10 | 10 | 10 | 18 | 18 |
| Styrene III | (B/S)₁ | kg | 25.2 | 13.9 | 13.9 | 13.9 | 13,9 | 13.9 | 17.1 | 17.1 |
| Butadiene II | (B/S)₂ | kg | | 42 | 42 | 42 | 42 | 42 | 18 | 18 |
| Styrene IV | (B/S)₂ | kg | | 25.4 | 20.3 | 20.3 | 20.3 | 20.3 | 17.1 | 17.1 |
| Butadiene III | (B/S)₃ | kg | | | | | | | 18 | 18 |
| Styrene V | (B/S)₃ | kg | | | 5.1 | 5.1 | 5.1 | 5.1 | 10.8 | 10.8 |
| | or S_{c} | | | | | | | | | |
| Styrene VI | S_{c} | kg | | | | | | | 6.4 | 6.4 |
| Edenol B-316 | | ml | | 531 | 531 | 531 | 531 | 551 | | |
| Diethyl | | ml | | | | | | | 128 | 128 |
| carbonate | | | | | | | | | | |

PTHL = potassium tetrahydrolinaloolate

Polystyrene with average intrinsic viscosity 96 (measured in 0.5% by weight solution in dimethylformamide [DMF] at 23° C.) was used as component B.

### Process Method:

The foam specimens were extruded in a tandem system. This was composed of a first extruder for melting of the polymer and for mixing to incorporate the blowing agent and a second extruder for cooling the melt comprising blowing agent. Styrene-butadiene-styrene block copolymer and polystyrene were introduced into the first extruder. The polymer was melted at 210° C., and all of the foam-forming additive was injected at a single point. Carbon dioxide was used as blowing agent. The melt comprising blowing agent was then cooled in a second extruder to the temperature needed for foaming: from 120 to 140° C. Throughput was about 200 kg/h, and the diameter of the annular die was 100 mm; its thickness was 2 mm.

The foam specimens were cut to give moldings of identical type and were tested in the tensile test in accordance with ASTM D638. Tensile modulus of elasticity was determined as a measure of stiffness, and tensile strain at break was determined as a measure of toughness, in both cases not only longitudinally with respect to the direction of extrusion (I) but also transversally (t), i.e. perpendicularly with respect to the direction of extrusion.

The results can be found in table B below.

TABLE B

| | | | | | Tensile | |
|---|---|---|---|---|---|---|
| | | | Width | | modulus | Tensile |
| Com- | Com- | | and | | of | strain at |
| ponent | ponent | Weight | length | Thickness | elasticity | break |
| A | B | [g] | [mm] | [mm] | [psi] | [%] |
| 0 | 100 | 0.42 | 10 × 100 | 2.42 | 11 985 (l) | 3.9 (l) |
| | | | | | 11 564 (t) | 4.3 (t) |
| 5 | 95 | 0.44 | 10 × 100 | 1.98 | 15 204 (t) | 4.8 (l) |
| | | | | | 14 392 (l) | 4.3 (t) |

1-5. (canceled)

6. A mixture which comprises
a) from 1 to 40% by weight of a styrene-butadiene-styrene block copolymer having)
1.) from 60 to 95% by weight of styrene monomer and
2.) from 5 to 50% by weight of diene monomer,
b) from 60 to 99% by weight of styrene polymer,
c) from 0 to 50% by weight of a filler, and
d) from 0.1 to 20% by weight of a foam-forming additive,
where the entirety of components a) to d) does not exceed 100% by weight.

7. The mixture according to claim 6, wherein fillers used comprise mineral fillers.

8. The mixture according to claim 6, wherein fillers comprise talc, calcium carbonate, titanium dioxide, or a mixture thereof.

9. The mixture as claimed in claim 6, which consists of
a) from 1 to 40% by weight of a styrene-butadiene-styrene block copolymer having)
1.) from 60 to 95% by weight of styrene monomer and
2.) from 5 to 50% by weight of diene monomer,
b) from 60 to 99% by weight of styrene polymer,
c) from 0 to 50% by weight of a filler, and
d) from 0.1 to 20% by weight of a foam-forming additive.

10. A process for producing mixture according to claim 6, which comprises
a) mixing components A, B, and C, where the mixing takes place to some extent or completely prior to or after feed to the extruder,
b) feeding components A, B, and C to the extruder,
c) melting and mixing in the extruder,
d) adding the foam-forming additive of component D,
e) extruding the mixture of components A, B, C, and D, where the foam-forming additive of component D expands after the extrusion process downstream of the discharge die to give the foam structure, optionally in a prescribed shape of a foil, of a film, or of a profile, and
f) optionally subjecting the foil, the film, or the profile to further processing.

11. A method of use of the mixture according to claim 6, for the preparation of a foil, film, hose, tube, packaging material, tableware, trays, and bowls, or for the preparation of foamed foils for food-and-drink packaging, XPS for the construction industry, profiles for insulation or decoration, or foamed plates, cups, and strips.

12. A process for the preparation of a foil, film, hose, tube, packaging material, tableware, trays, or bowls which comprises utilizing the mixture according to claim 6.

13. A process for the for the preparation of foamed foils for food-and-drink packaging, XPS for the construction industry, profiles for insulation or decoration, or foamed plates, cups, and strips which comprises utilizing the mixture according to claim 6.
